(19) United States
(12) Patent Application Publication
(10) Pub. No.: US 2021/0178768 A1
(43) Pub. Date: Jun. 17, 2021

(54) LIQUID DISCHARGE APPARATUS

(71) Applicant: BROTHER KOGYO KABUSHIKI KAISHA, Nagoya (JP)

(72) Inventor: Mitsugi TANAKA, Nagoya (JP)

(21) Appl. No.: 17/120,701

(22) Filed: Dec. 14, 2020

(30) Foreign Application Priority Data
Dec. 16, 2019 (JP) 2019-226773

(51) Int. Cl. B41J 2/17; B41J 29/02; B41J 2/175; B41J 29/13

(52) U.S. Cl. CPC B41J 2/1721; B41J 29/13; B41J 2/1752; B41J 29/02

(57) ABSTRACT

A liquid discharge apparatus includes: a casing having a first surface, a second surface, a third surface, a fourth surface, a fifth surface and a sixth surface, the first surface having a first opening and a discharge opening; a waste liquid storage section configured to be pulled out from the casing through the first opening; a sheet accommodating section positioned between the waste liquid storage section and the second surface in the first direction; a conveyor configured to convey the continuous sheet that extends from the sheet accommodating section to the discharge opening; a head positioned between the waste liquid storage section and the fifth surface in the third direction; and a maintenance unit positioned between the waste liquid storage section and the fifth surface in the third direction, configured to receive liquid discharged from the head, and connected to the waste liquid storage section.

### CROSS REFERENCE TO RELATED APPLICATION

The present application claims priority from Japanese Patent Application No. 2019-226773 filed on Dec. 16, 2019, the disclosure of which is incorporated herein by reference in its entirety.

### BACKGROUND OF THE INVENTION

### Field of the Invention

The present disclosure relates to a liquid discharge apparatus having a waste liquid storage section for storing liquid which is discharged from a head to a maintenance unit.

### Description of the Related Art

In the internal space of the conveying apparatus for conveying the sheet extending from the rolled paper, there is a rolled paper loading section for accommodating the rolled paper. The roll paper is loaded into the roll paper loading section through a supply port for the roll paper formed on a right side surface of the apparatus case. A replacement port for a waste ink tank is formed on the right side surface of the apparatus case (see Japanese Patent Laid-Open No. 2015-120578). When the opening/closing cover on a front surface of the apparatus case is pulled out, a platen unit is pulled out forward to open the conveyance path (Japanese Patent Laid-Open No. 2015-120586 corresponding to U.S. Patent Publication No. 2015/0197105).

In the conveying apparatus disclosed in Japanese Patent Laid-Open No. 2015-120578, the waste ink tank is replaced through the replacement port formed on the side surface of the apparatus case. For this purpose, space adjacent to the side surface (the replacement port) of the apparatus case is required for the work. Further, in the conveying device disclosed in Japanese Patent Laid-Open No. 2015-120578 and No. 2015-120586, a platen unit or the like is disposed in front of the roll paper in the apparatus case. By operating the opening/closing cover provided with the front of the device case, the platen unit can be pulled out. Therefore, the user cannot access the waste ink tank from the front surface of the apparatus case.

The present disclosure has been made in view of the above-mentioned circumstances, and an object thereof is to provide a liquid discharge apparatus in which a waste liquid storage section can be pulled out from a front surface of a casing of the apparatus.

### SUMMARY

According to an aspect of the present disclosure, there is provided a liquid discharge apparatus, including:

a casing having a first surface and a second surface positioned apart from each other in a first direction, a third surface and a fourth surface positioned apart from each other in a second direction perpendicular to the first direction, and a fifth surface and a sixth surface positioned apart from each other in a third direction perpendicular to the first direction and the second direction, the first surface having a first opening and a discharge opening through which a continuous sheet is discharged;

a waste liquid storage section positioned in an internal space of the casing and configured to be pulled out from the casing through the first opening;

a sheet accommodating section positioned between the waste liquid storage section and the second surface in the first direction in the internal space of the casing and configured to accommodate the continuous sheet;

a conveyor configured to convey the continuous sheet that extends from the sheet accommodating section to the discharge opening;

a head positioned between the waste liquid storage section and the fifth surface in the third direction in the internal space of the casing and configured to discharge liquid droplets; and

a maintenance unit positioned between the waste liquid storage section and the fifth surface in the third direction in the internal space of the casing, configured to receive liquid discharged from the head, and connected to the waste liquid storage section so that the liquid flows to the waste liquid storage section.

### BRIEF DESCRIPTION OF THE DRAWINGS

FIG. 1 is a perspective view of an external appearance of an image recording apparatus according to an embodiment of the present disclosure.

FIG. 2 is a perspective view of an external appearance of the image recording apparatus with a front cover and a side cover opened.

FIG. 3 is a perspective view depicting side frames and a subframe attached to a base.

FIG. 4 is a cross-sectional view taken along a line IV-IV of FIG. 1, wherein a maintenance unit is in a standby position.

FIG. 5 is a cross-sectional view taken along a line V-V of FIG. 4.

FIG. 6 is a cross-sectional view taken along a line VI-VI of FIG. 4.

FIG. 7 depicts a schematic configuration of a circulation mechanism.

FIG. 8 is a cross-sectional view of a first support mechanism and the maintenance unit that have pivoted downward.

FIG. 9 is a cross-sectional view of the first support mechanism pivoting downward and the maintenance unit in a maintenance position.

### DESCRIPTION OF THE EMBODIMENTS

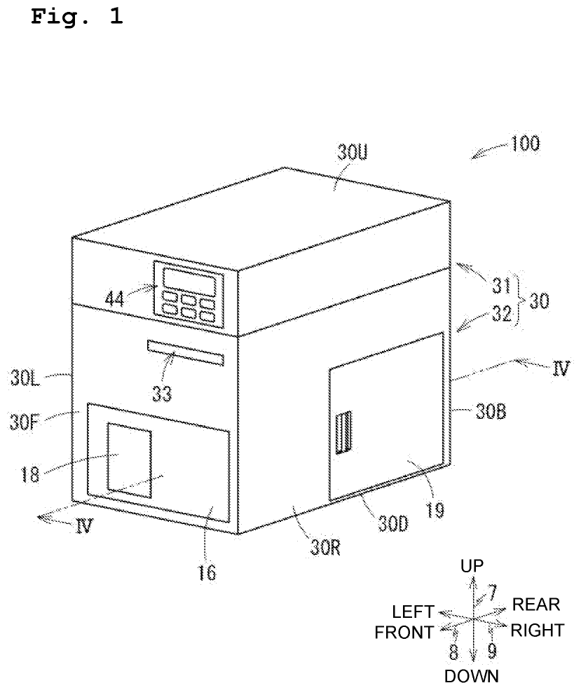

An image recording apparatus 100 according to an embodiment of the present disclosure is explained below. Note that the embodiment explained below is merely an example of the present disclosure, and it goes without saying that the embodiment can be appropriately changed in a range that does not alter the gist or essential characteristics of the present disclosure. In the following, movement directed from a start point to an end point of an arrow is expressed as an orientation, and reciprocating movement on a line connecting the start point and the end point of the arrow is expressed as a direction. Further, an up-down direction (a third direction) 7 is defined with reference to a state (the state of FIG. 1) where the image recording apparatus 100 is usably disposed. A front-rear direction (a first direction) 8 is defined assuming a side provided with a discharge opening 33 to be a front side (a front surface). A left-right direction (a second direction) 9 is defined viewing the image recording apparatus 100 from the front side (front surface).

<Configuration of External Appearance of Image Recording Apparatus 100>

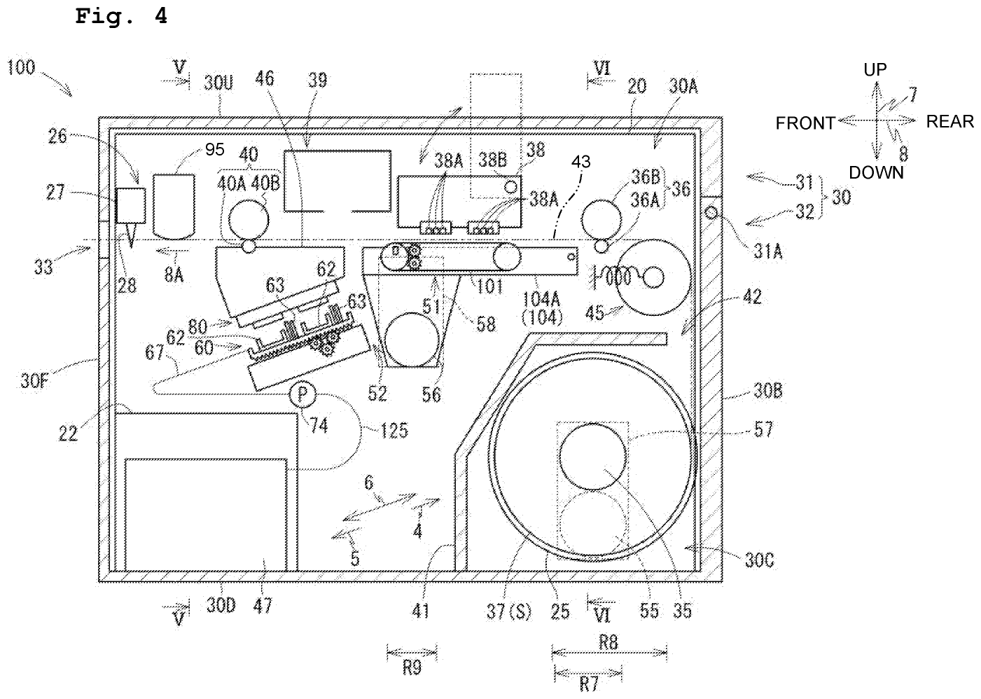

The image recording apparatus 100 (an example of a liquid discharge apparatus) depicted in FIG. 1 records an image on a sheet S (an example of a continuous sheet) formed in a roll body 37 (see FIG. 4) in accordance with an ink-jet recording system.

As depicted in FIG. 1, the image recording apparatus 100 includes a casing 30. The casing 30 includes an upper casing 31 (an upper unit or an example of a first unit) and a lower casing 32 (a lower unit or an example of a second unit). The upper casing 31 and the lower casing 32 have a substantially rectangular parallelepiped shape as a whole, and have a size that can be placed on a table. The following explanation of the casing 30 is made in a state where the upper casing 31 and the lower casing 32 have the rectangular parallelepiped shape as a whole.

The casing 30 has a right surface 30R, a left surface 30L, an upper surface 30U, a lower surface 30D, a front surface 30F, and a rear surface 30B. The right surface 30R and the left surface 30L are positioned apart in the left-right direction 9. The upper surface 30U and the lower surface 30D are positioned apart in the up-down direction 7. The front surface 30F and the rear surface 30B are positioned apart in the front-rear direction 8. That is, the casing 30 has the front surface 30F and the rear surface 30B (an example of a first surface and an example of a second surface) positioned apart in the front-rear direction (the first direction) 8, the left surface 30L and the right surface 30R (an example of a third surface and an example of a fourth surface) positioned apart in the left-right direction (the second direction) 9 perpendicular to the front-rear direction (the first direction) 8, and the upper surface 30U and the lower surface 30D (an example of a fifth surface and an example of a sixth surface) positioned apart in the up-down direction (the third direction) 7 perpendicular to the front-rear direction (the first direction) 8 and the left-right direction (the second direction) 9.

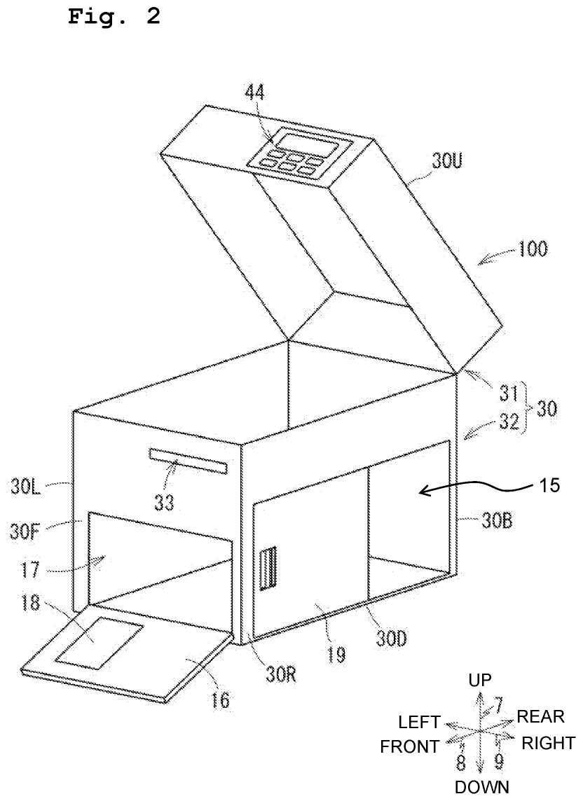

The rear surface 30B of the upper casing 31 is connected to the lower casing 32 so that the upper casing 31 is pivotable around a pivot axis 31A (see FIG. 4) extending in the left-right direction 9. The upper casing 31 pivotally moves from a closed position depicted in FIG. 1 so that the front surface 30F is lifted upward to an opened position depicted in FIG. 2. When the upper casing 31 is in the opened position, an internal space 30A of the casing 30 (see FIG. 4) is exposed to the outside. In FIG. 2, an internal structure of the casing 30 is omitted.

As depicted in FIG. 1, the front surface 30F of the casing 30 is formed having the discharge opening 33 that is long in the left-right direction 9. A center portion in the left-right direction 9 of the discharge opening 33 is positioned at the right of a center portion in the left-right direction 9 of the front surface 30F. The discharge opening 33 causes the internal space 30A of the casing 30 to communicate with the outside. The sheet S for which image recording has been performed in the internal space 30A of the casing 30 is discharged to the outside of the casing 30 through the discharge opening 33.

An operation panel 44 is provided on the front surface 30F of the casing 30. The operation panel 44 is positioned above the discharge opening 33. A user inputs, to the operation panel 44, instructions for operating the image recording apparatus 100 and confirming a variety of kinds of settings.

The front surface 30F of the casing 30 is provided with a front cover (a first cover) 16. The front cover 16 is positioned below the discharge opening 33. The front cover 16 is pivotable around a pivot axis extending on the front surface 30F in the left-right direction 9 with an upper end of the front cover 16 in the closed position depicted in FIG. 1 as a pivot end. When the upper end of the front cover 16 in the closed position pivots to be pulled forward, the front cover 16 has the opened position depicted in FIG. 2.

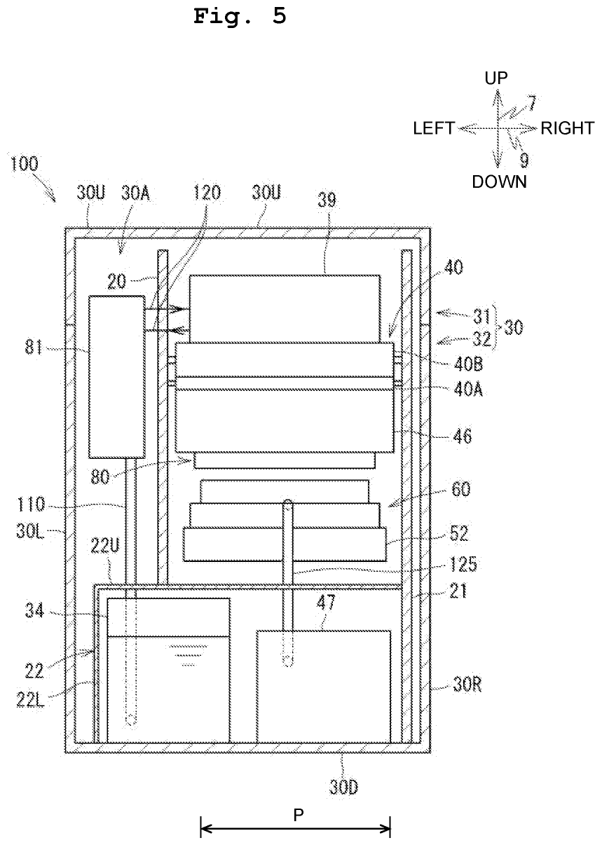

As depicted in FIG. 2, when the front cover 16 is in the opened position, an opening (a first opening) 17 formed in the front surface 30F is opened. The opening 17 allows the internal space 30A of the casing 30 to communicate with the outside. A user is accessible to a tank 34 (see FIG. 5) and a waste liquid tank 47 (see FIG. 5) arranged in the internal space 30A of the casing 30 through the opening 17 opened. The opening 17 is opened and closed by the front cover 16 as described above.

The front cover 16 is provided with a window 18. The window 18 may be a through hole formed in the front cover 16. The through hole as the window 18 may be sealed with a translucent member. A user can visually recognize the internal space 30A from the outside of the casing 30 through the window 18 of the front cover 16 in the closed position. The window 18 of the front cover 16 in the closed position faces the tank 34. The user can thus visually recognize the tank 34 from the outside of the casing 30 through the window 18, even when the front cover 16 is in the closed position. The user can visually recognize a liquid level of ink stored in the tank 34 by forming at least part of the tank 34 by a translucent member.

As depicted in FIGS. 1 and 2, a side cover (a second cover) 19 is positioned in the right surface 30R of the lower casing 32. The side cover 19 is slidable with respect to the lower casing 32 along the front-rear direction 8. An opening (a second opening) 15 is formed in the right surface 30R. The opening 15 is opened and closed by sliding the side cover 19. The opening 15 causes a sheet accommodating space 30C to communicate with the outside. That is, the opening/closing of the side cover 19 causes the sheet accommodating space 30C (see FIG. 4) to be opened and closed with respect to the outside. Opening the side cover 19 exposes a holder 35 to the outside, which allows the roll body 37 to be installed to the holder 35.

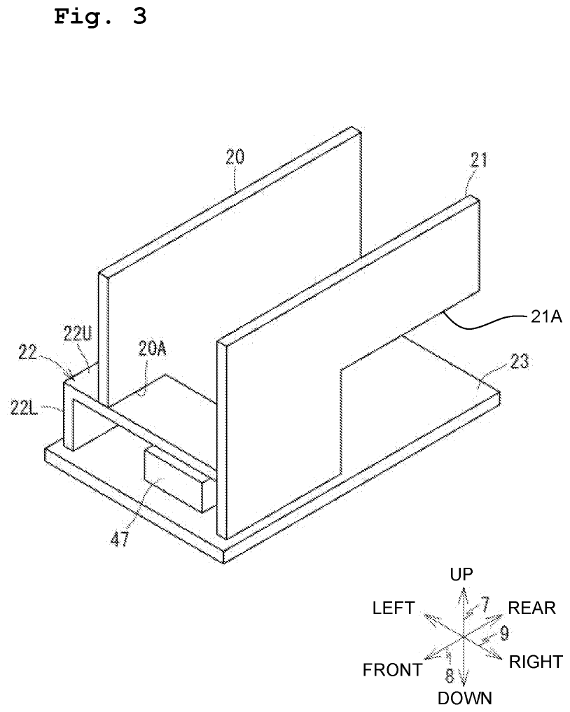

As depicted in FIG. 3, the internal space 30A of the casing 30 is provided with two side frames 20 and 21 (an example of a first side frame and an example of a second side frame) and a subframe 22. Each of the side frames 20 and 21 has a flat plate shape made from a steel plate. A cutout (notch) and/or a through hole is/are appropriately formed in each of the side frames 20 and 21. The cutout and/or the through hole have a shape(s) depending on a member supported by each of the side frames 20 and 21. Each of the side frames 20 and 21 may be bent to increase strength. The two side frames 20 and 21 are positioned apart in the left-right direction 9. Although not depicted in FIG. 3, the side frames 20 and 21 form an integral frame structure by using any other frame coupling the side frames 20 and 21. The side frames 20 and 21 are coupled to a base 23 that forms the lower surface 30D of the casing 30. The frames, including the side frames 20 and 21, are coupled with each other by screws, welding, or the like.

Of the two side frames 20 and 21, a front lower corner of the side frame 20 positioned at the left in the left-right direction 9 is formed having a cutout (notch) 20A. A front end of the side frame 20 is thus not coupled to the base 23, and the front end of the side frame 20 has a space corresponding to the cutout 20A. The space corresponding to the cutout 20A is provided with the subframe 22. A rear lower corner of the side frame 21 is formed having a cutout (notch) 21A. The cutout 21A is an opening through which the roll body 37 is installed in the sheet accommodating space 30C (see FIG. 4). A user is accessible to the sheet accommodating space 30C from the outside through the cutout 21A and the opening (the second opening) 15 formed in the right surface 30R of the casing 30.

The subframe 22 has an upper wall 22U and a left wall 22L. The left wall 22L and the side frame 21 are positioned apart in the left-right direction 9. The upper wall 22U couples an upper end of the left wall 22L to the side frame 21. A lower end of the left wall 22L is coupled to the base 23. The upper wall 22U is coupled to the cutout 20A of the side frame 20. The subframe 22 is thus positioned below the front portion of the side frame 20 so that the subframe 22 and the two side frames 20, 21 form the integral frame. The tank 34 and the waste liquid tank 47 are positioned in a space surrounded by the subframe 22 (see FIG. 5).

<Internal Configuration of Image Recording Apparatus 100>

As depicted in FIG. 4 and FIG. 5, the holder 35, a tensioner 45, a conveyance roller pair 36, a discharge roller pair 40, a head 38, the first support mechanism 51, a fixing unit 39, a support member 46, a second support mechanism 52, a contact image sensor (CIS) 95, a cutter unit 26, the tank 34, the waste liquid tank 47, a maintenance unit 60, and a wiper cleaning unit 80 are arranged in the internal space 30A.

In the internal space 30A, a partition wall 41 is provided between the side frames 20 and 21 in the left-right direction 9. The partition wall 41 partitions a rear lower portion of the internal space 30A to define the sheet accommodating space 30C (an example of a sheet accommodating section). The sheet accommodating space 30C is a space surrounded by the partition wall 41 and the lower casing 32 and separated or isolated from the head 38 and the like.

The roll body 37 is accommodated in the sheet accommodating space 30C. The roll body 37 has a core tube and the long sheet S. The sheet S is wound around the core tube in a roll shape in a circumferential direction of an axial core of the core tube. The sheet S may have a width ranging from a minimum width to a maximum width in which the image recording apparatus 100 is capable of recording an image. That is, a plurality of types of the roll body 37 having different widths are accommodatable in the sheet accommodating space 30C. The roll body 37 may not have the core tube, and the sheet S may be formed in a roll shape so that the sheet S is installable in the holder 35.

The holder 35 extending in the left-right direction 9 is positioned in the sheet accommodating space 30C. The roll body 37 can be installed in the holder 35. When the roll body 37 is installed in the holder 35, the holder 35 supports the roll body 37 so that the axial core of the core tube of the roll body 37 is along the left-right direction 9 and the roll body 37 is rotatable in the circumferential direction of the axial core.

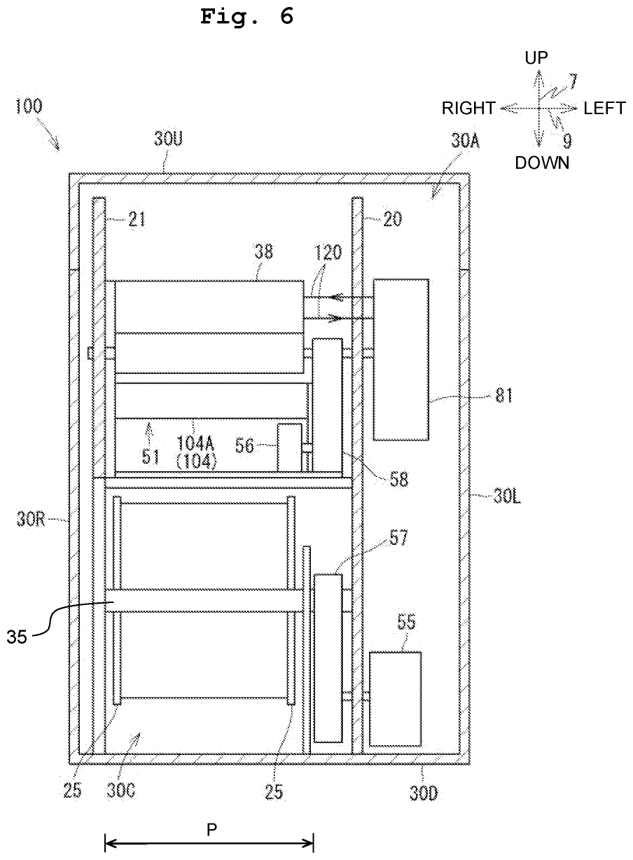

As depicted in FIG. 4 and FIG. 6, the holder 35 is provided with a pair of side guides 25 separated from each other in the left-right direction 9. A distance between the side guides 25 in the left-right direction 9 is changeable. A user moves the pair of side guides 25 so that the side guides 25 come into contact with or abut against left and right ends of the roll body 37 according to the width of the roll body 37 to be installed to the holder 35 (the size along the left-right direction 9). The roll body 37, of which left and right ends are brought into contact with the side guides 25, is positioned so that a center portion in the width direction of the sheet S is coincident with a center portion in the left-right direction 9 of a conveyance route 43 through which the sheet S is conveyed.

The holder 35 rotates around an axis along the left-right direction 9 when a first driving transmission mechanism 57 transmits driving force of a first motor 55 described below to the holder 35. Along with the rotation of the holder 35, the roll body 37 supported by the holder 35 also rotates.

A rear portion of the sheet accommodating space 30C is opened upward. Specifically, a gap 42 is formed between the partition wall 41 and the rear surface 30B, that is, formed above a rear end of the roll body 37. Rotating the conveyance roller pair 36 and the discharge roller pair 40 pulls out the sheet S upward from the rear end of the roll body 37, and the sheet S pulled out is guided to the tensioner 45 via the gap 42.

In the internal space 30A, the tensioner 45 is positioned between the side frames 20 and 21 in the left-right direction 9. At a rear portion of the internal space 30A, the tensioner 45 is positioned above the partition wall 41. The tensioner 45 is a roller that is supported by the side frames 20 and 21 so that the tensioner 45 is rotatable and movable in the front-rear direction 8. Rearward urging force is applied to the tensioner 45 by an urging member such as a spring.

In the internal space 30A, the conveyance roller pair 36 (an example of a conveyor) is positioned between the side frames 20 and 21 in the left-right direction 9. The conveyance roller pair 36 is positioned at the front side of the tensioner 45. The conveyance roller pair 36 has a conveyance roller 36A and a pinch roller 36B. The conveyance roller 36A is rotatably supported by the side frames 20 and 21. The conveyance roller 36A rotates around an axis direction that is along the left-right direction 9. The conveyance roller 36A rotates when receiving driving force from a second motor 56 described below through a second driving transmission mechanism 58, thus conveying the sheet S frontward (conveyance orientation 8A) while nipping the sheet S between the conveyance roller 36A and the pinch roller 36B.

In the internal space 30A, the discharge roller pair 40 (an example of the conveyor) is positioned between the side frames 20 and 21 in the left-right direction 9. The discharge roller pair 40 is positioned at the front side of the conveyance roller pair 36. The discharge roller pair 40 has a discharge roller 40A and a pinch roller 40B. The discharge roller 40A is rotatably supported by the side frames 20 and 21. The discharge roller 40A rotates around an axis direction that is along the left-right direction 9. The discharge roller 40A rotates when receiving driving force from the second motor 56 described below through the second driving transmission mechanism 58, thus conveying the sheet S frontward (conveyance orientation 8A) while nipping the sheet S between the discharge roller 40A and the pinch roller 40B.

In the internal space 30A, the head 38 is positioned between the side frames 20 and 21 in the left-right direction 9. The head 38 is positioned downstream of the conveyance roller pair 36 in the conveyance orientation 8A. The head 38 has nozzles 38A. Ink is discharged downward, as liquid droplets, from the nozzles 38A toward the sheet S supported by a conveyance belt 101. Accordingly, an image is recorded on the sheet S. In this embodiment, ink contains a resin that is cured by ultraviolet light.

As depicted in FIG. 4, the head 38 is pivotable about a pivot axis 38B positioned at a rear end of the head 38 and extending in the left-right direction 9. The head 38 indicated by a solid line in FIG. 4 is in a first position where liquid droplets are discharged toward the first support mechanism 51. The head 38 indicated by a broken line in FIG. 4 is in a second position where an upper portion of the first support mechanism 51 is opened. That is, the head 38 in the second position opens part of the conveyance route 43.

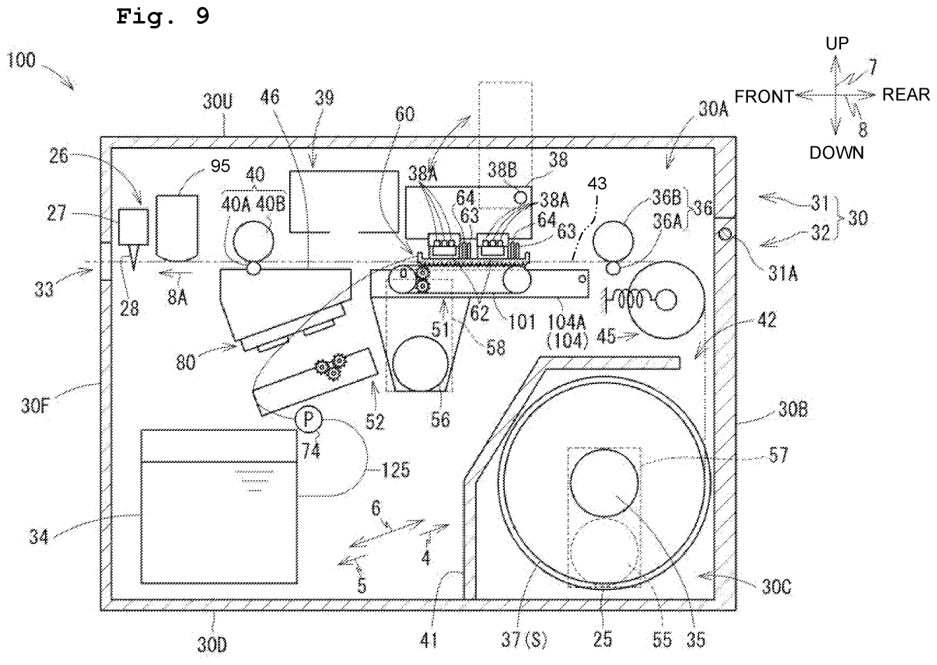

In the internal space 30A, the first support mechanism 51 is positioned between the side frames 20 and 21 in the left-right direction 9. The first support mechanism 51 is positioned downstream of the conveyance roller pair 36 in the conveyance orientation 8A. The first support mechanism 51, which is positioned below the head 38, faces the head 38. The first support mechanism 51 has the conveyance belt 101 and a support portion 104. The support portion 104 is capable of supporting the maintenance unit 60 in a maintenance position (see FIG. 9). The support portion 104 includes a frame 104A having a surface extending in the up-down direction 7 and the front-rear direction 8. Part of the second driving transmission mechanism 58 is rotatably attached to the frame 104A to support the second driving transmission mechanism 58. The first support mechanism 51 and the conveyance belt 101 are an exemplary conveyance belt unit.

The conveyance belt 101 is formed as follows. That is, an endless belt is stretched between two pullies that are separated from each other in the front-rear direction 8 and rotate around an axis extending along the left-right direction 9. An axis direction of the conveyance belt 101 is parallel to an axis direction of the holder 35. When one of the two pullies of the conveyance belt 101 receives driving force of the second motor 56 through the second driving transmission mechanism 58, rotary motion of the endless belt is caused to convey the sheet S in the conveyance orientation 8A. The sheet S is supported by the endless belt during the conveyance. The two pullies are rotatably attached to the frame 104A of the support portion 104. That is, the support portion 104 supports the two pullies.

In the internal space 30A, the fixing unit 39 is positioned between the side frames 20 and 21 in the left-right direction 9. The fixing unit 39 is positioned downstream of the head 38 in the conveyance orientation 8A and upstream of the discharge roller pair 40 in the conveyance orientation 8A. The fixing unit 39 is an ultraviolet irradiator having a substantially rectangular parallelepiped shape that is long in the left-right direction 9. The fixing unit 39 irradiates the sheet S passing directly below the fixing unit 39 and ink on the sheet S with ultraviolet light. The resin in the ink irradiated with ultraviolet light is cured, and a pigment in the ink is fixed to the sheet S.

The fixing unit 39 is not limited to the ultraviolet irradiator. For example, when ink contains thermoplastic resin fine particles, the fixing unit 39 may be a heater. In this case, the thermoplastic resin fine particles are melted by heating the sheet S and ink on the sheet S with the fixing unit 39, and the melted resin is cured by cooling performed thereafter. Accordingly, the pigment in ink is fixed to the sheet S.

In the internal space 30A, the support member 46 is positioned between the side frames 20 and 21 in the left-right direction 9. The support member 46 is positioned downstream of the head 38 and the first support mechanism 51 in the conveyance orientation 8A. A rear portion of the support member 46 faces the fixing unit 39. A front portion of the support member 46 faces the discharge roller 40A. The support member 46 supports the sheet S conveyed in the conveyance orientation 8A by the conveyance belt 101 of the first support mechanism 51.

The second support mechanism 52 is positioned below the support member 46. The second support mechanism 52 can support the maintenance unit 60 in a standby position.

The CIS 95 is positioned downstream of the discharge roller pair 40 in the conveyance orientation 8A. In the CIS 95, light that is emitted from a light source such as an LED is reflected by a sheet. The reflection light is collected to a line sensor by a refractive index distribution type lens. The line sensor outputs an electric signal depending on intense of the reflection light received. The CIS 95 can read an image on a printing surface (upper surface) of the sheet S. The CIS 95 is disposed so that a reading line extends in the left-right direction 9.

The cutter unit 26 is positioned downstream of the CIS 95 in the conveyance orientation 8A. The cutter unit 26 is configured so that a cutter 28 is carried on a cutter carriage 27. The cutter carriage 27 moves in the left-right direction 9 by a belt driving mechanism (not depicted). The cutter 28 moves in the left-right direction 9 along with movement of the cutter carriage 27. The sheet S positioned between the discharge roller pair 40 and the discharge opening 33 is cut along the left-right direction 9 through movement of the cutter 28.

As depicted in FIG. 5, the tank 34 is a container having a rectangular parallelepiped shape. The tank 34 stores ink in its internal space. The tank 34 is positioned in a space surrounded by the subframe 22 at the front lower side of the internal space 30A. The tank 34 is surrounded by the subframe 22, the side frame 21, and the base 23. The internal space of the tank 34 is connected to the head 38 via a tube (not depicted) so that ink is supplied to the head 38. In this embodiment, the tank 34 is a cartridge-type that is removable with respect to the casing 30.

As depicted in FIG. 4 and FIG. 5, the waste liquid tank 47 (an example of a waste liquid storage section) is a container having a rectangular parallelepiped shape. The waste liquid tank 47 holds ink in its internal space. The waste liquid tank 47 is positioned between the subframe 22 and the side frame 21 at the lower front side of the internal space 30A. The waste liquid tank 47 is surrounded by the subframe 22, the side frame 21, and the base 23. The interior space of the waste liquid tank 47 is connected to the maintenance unit 60 via a tube (not depicted) so that ink discharged from the maintenance unit 60 flows therethrough. In this embodiment, the waste liquid tank 47 is a cartridge-type that is replaceable with respect to the casing 30.

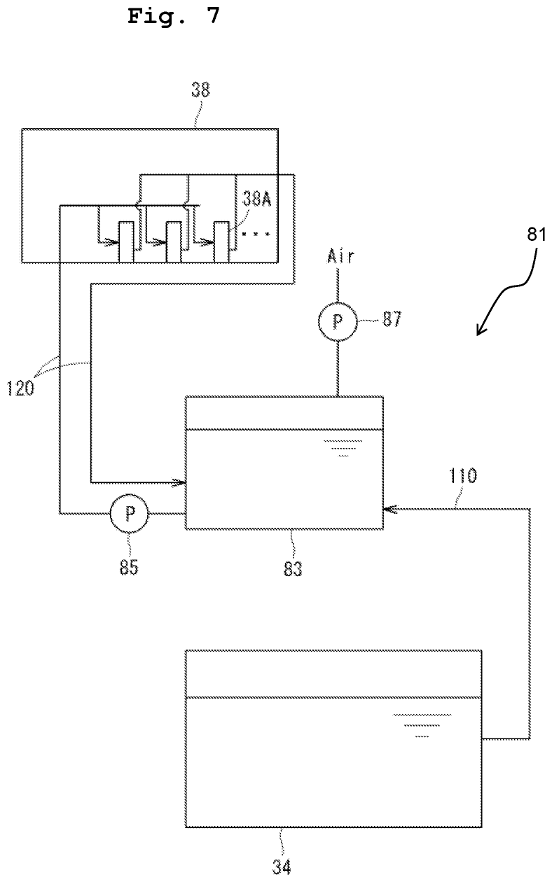

As depicted in FIG. 6, a circulation mechanism 81 (an example of a supply unit) is positioned in the internal space 30A at the left of the side frame 20 in the left-right direction 9. The circulation mechanism 81 is supported by the side frame 20. As depicted in FIG. 7, the circulation mechanism 81 includes a subtank 83, the first pump 85 (an example of a pump), and the second pump 87. The subtank 83 and pumps 85 and 87 are connected to the tank 34 and the nozzles 38A of the head 38 via channels 110 and 120. Each of the channels 110 and 120 is provided with a valve as appropriate. In this embodiment, the valve is omitted. Each of the channels 110 and 120 may be configured by a tube or the like.

Specifically, the tank 34 is connected to the subtank 83 by the channel 110, and ink can be supplied from the tank 34 to the subtank 83. The subtank 83 is in atmospheric communication with the outside via the second pump 87. When the second pump 87 is driven, pressure inside the subtank 83 becomes negative, and ink is supplied from the tank 34 to the subtank 83. When ink is supplied from the tank 34 to the subtank 83, the channel(s) 120 between the subtank 83 and the head 38 is/are closed. When the first pump 85 is driven, ink circulates through the channel(s) 120 between the subtank 83 and the nozzles 38A of the head 38.

The maintenance unit 60 performs maintenance of the head 38. The maintenance unit 60 is movable between the side frames 20 and 21 in the up-down direction 7 and the front-rear direction 8. The maintenance unit 60 is positioned directly below the head 38 when maintenance of the head 38 is performed (see FIG. 9, the maintenance position).

The maintenance of the head 38 includes a flushing process, a purge process, a wiping process, and the like. In the flushing process, ink is discharged toward the maintenance unit 60. In the purge process, ink is sucked from the nozzles 38A by a suction pump 74 in a state where the nozzles 38A are covered with a cap 62 of the maintenance unit 60. In the wiping process, a nozzle surface of the head 38 is wiped with a wiper 63 of the maintenance unit 60. Ink discharged to the cap 62 through the flushing process and the purge process is discharged to the waste liquid tank 47 through a channel 125.

The wiper cleaning unit 80 cleans the wiper 63 of the maintenance unit 60. The wiper cleaning unit 80 faces downward by being supported by the support member 46. The maintenance unit 60 moves to a position directly below the wiper cleaning unit 80 when cleaning of the wiper 63 is performed.

The maintenance unit 60 is movable in an inclination direction 6 by sliding with respect to the second support mechanism 52 in a state of being supported by the second support mechanism 52. The maintenance unit 60 supported by the second support mechanism 52 moves along the inclination direction 6, which allows the wiper 63 to move while being brought into contact with the wiper cleaning unit 80. This wipes ink adhering to the wiper 63 off.

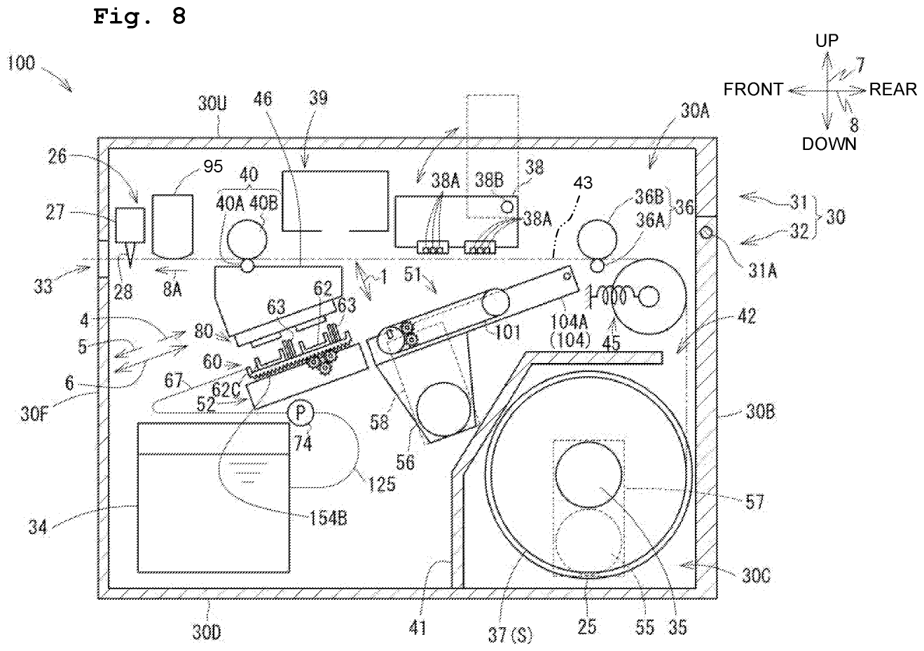

As depicted in FIG. 4, the maintenance unit 60 in the standby position is supported by the second support mechanisms 52. When a motor (not depicted) is driven, as depicted in FIG. 8, a front portion of the first support mechanism 51 and the conveyance belt 101 pivot to move downward. This allows the maintenance unit 60 to move from the second support mechanism 52 to the first support mechanism 51. When the second driving transmission mechanism 58 transmits driving force of the second motor 56 to the second driving transmission mechanism 58, the maintenance unit 60 in the standby position moves in an orientation 4 in the inclination direction 6 while being guided by the second support mechanism 52 and the first support mechanism 51 and then the maintenance unit 60 is supported by the first support mechanism 51.

Driving force is transmitted from the motor (not depicted) in a state where the maintenance unit 60 is supported only by the first support mechanism 51. This causes the front portion of the first support mechanism 51 to pivot and move upward. Thus, the maintenance unit 60 is positioned in the maintenance position, as depicted in FIG. 9. The standby position is at the front side of the maintenance position and above the tank 34.

As depicted in FIG. 9, the head 38 moves downward with respect to the maintenance unit 60 in the maintenance position, thus covering the nozzles 38A with the cap 62 of the maintenance unit 60. The purge process can be executed in this state. The wiping process is executed by moving the maintenance unit 60 positioned in the maintenance position along the first support mechanism 51 in the front-rear direction 8.

When the maintenance unit 60 moves from the maintenance position to the standby position, an operation reverse to the above is executed.

<Arrangement in Internal Space 30A of Casing 30>

As depicted in FIG. 4, the sheet accommodating space 30C is positioned in the internal space 30A of the casing 30 at the rear side of the waste liquid tank 47 in the front-rear direction 8. The head 38 and the maintenance unit 60 are positioned above the waste liquid tank 47 in the up-down direction 7. Thus, in this embodiment, the sheet accommodating space 30C, the head 38, and the maintenance unit 60 are not arranged between the maintenance unit 60 and a wall (front wall) including the front surface 30F of the casing 30. That is, the maintenance unit 60 is adjacent to the wall (front wall) including the front surface 30F of the casing 30. In the state where the front cover 16 is in the closed position (FIG. 1), the maintenance unit 60 faces the front cover 16. In the state where the front cover 16 is in the opened position (FIG. 2), the maintenance unit 60 is opened (exposed) to the outside through the opening (first opening) 17.

As depicted in FIGS. 5 and 6, a right portion of the tank 34, the head 38, the maintenance unit 60, and the waste liquid tank 47 are positioned, in the left-right direction 9, in a range (a width in the left-right direction 9 of the conveyance route 43) P of the conveyance route 43 through which the sheet S passes.

The circulation mechanism 81 is positioned above the tank 34 in the up-down direction 7. As depicted in FIG. 6, the head 38 is positioned at the right of the circulation mechanism 81 in the left-right direction 9. As depicted in FIGS. 5 and 6, the maintenance unit 60 is positioned at the right of the circulation mechanism 81 in the left-right direction 9 below the head 38 in the up-down direction 7. The waste liquid tank 47 is positioned at the right of the tank 34 in the left-right direction 9.

As depicted in FIG. 7, a channel through which ink flows from the tank 34 to the circulation mechanism 81 is formed by a tube or the like. Similarly, a channel through which ink flows from the circulation mechanism 81 to the head 38 is formed by a tube or the like. The head 38 discharges ink to the maintenance unit 60 in the maintenance position. A channel through which ink flows from the maintenance unit 60 to the waste liquid tank 47 is formed by a tube or the like.

<Working Effect of Embodiment>

As depicted in FIG. 4, in the liquid discharge apparatus of this embodiment, the sheet accommodating space 30C is positioned at the rear side of the waste liquid tank 47 in the front-rear direction 8 in the internal space 30A of the casing 30. That is, the sheet accommodating space 30C is positioned between the waste liquid tank 47 and the rear surface 30B in the front-rear direction 8. The head 38 and the maintenance unit 60 are positioned above the waste liquid tank 47 in the up-down direction 7. That is, the head 38 and the maintenance unit 60 are positioned between the waste liquid tank 47 and the upper surface 30U in the up-down direction 7.

According to the above configuration, the waste liquid tank 47 can be pulled out through the opening 17 of the front surface 30F of the casing 30, and thus operability is good.

The liquid discharge apparatus 100 of this embodiment further includes a side cover 15 with which the opening 15 of the right surface 30R of the casing 30 is opened and closed. The side cover 15 is slidable with respect to the casing 30 along the front-rear direction 8. The roll body 37 (sheet S) is installable in the sheet accommodating space 30C through the opening of the right surface 30R of the casing 30.

According to the above configuration, the waste liquid tank 47 is pulled out frontward. Thus, the side cover 19 can slide in the front-rear direction 8 without interfering with a space at the front side of the casing 30 for pulling out the waste liquid tank 47.

In the liquid discharge apparatus 100 of this embodiment, the waste liquid tank 47, the sheet accommodating space 30C, the conveyance roller pair 36, the discharge roller pair 40, the head 38, and the maintenance unit 60 are positioned between the two side frames 20 and 21 in the left-right direction 9.

According to the above configuration, the cutouts for pulling out the waste liquid tank 47 are not required in the side frames 20 and 21, and thus strength of the side frames 20 and 21 is improved.

In the liquid discharge apparatus 100 of this embodiment, the internal space 30A of the casing 30 is opened to the outside by moving the upper casing 31 with respect to the lower casing 32.

According to the above configuration, the internal space 30A of the casing 30 is opened to the outside by pivoting the upper casing 31 with respect to the lower casing 32. A user is thus accessible to the internal space 30A from above the casing 30, for example, in order to get rid of paper jam.

In the liquid discharge apparatus 100 of this embodiment, the head 38 is pivotable between the first position where liquid droplets are discharged to the sheet S and the second position where the conveyance route 43 through which the sheet S passes is opened.

According to the above configuration, the conveyance route 43 through which the sheet S passes is opened to the outside in the state where the head 38 is in the second position. This allows a user to easily solve a trouble, such as paper jam.

In the liquid discharge apparatus 100 of this embodiment, the circulation mechanism 81 is positioned above the tank 34 in the up-down direction 7. The head 38 is positioned at one side in the left-right direction 9 of the circulation mechanism 81. The maintenance unit 60 is positioned at the one side in the left-right direction 9 of the circulation mechanism 81 and at the lower side in the up-down direction 7 of the head 38. The waste liquid tank 47 is positioned at the one side in the left-right direction 9 of the tank 34. That is, in the liquid discharge apparatus 100 of this embodiment, the tank 34 and the circulation mechanism 81 are arranged in this order from the bottom in the up-down direction 7. The head 38, the maintenance unit 60, and the waste liquid tank 47 are arranged in this order from the top in the up-down direction 7. The head 38, the maintenance unit 60, and the waste liquid tank 47 are positioned at the same side in the left-right direction 9 of the tank 34 and the circulation mechanism 81. That is, all of the head 38, the maintenance unit 60, and the waste liquid tank 47 are positioned at the right or left of the tank 34 and the circulation mechanism 81.

According to the above configuration, the channels of the tank 34, the circulation mechanism 81, the head 38, the maintenance unit 60, and the waste liquid tank 47, through which ink flows in this order, can be arranged not to intersect with each other when seen from the front-rear direction 8.

### MODIFICATIONS

In the above embodiment, the tank 34 and the waste liquid tank 47 are replaceable independently. However, the tank 34 may be formed integrally with the waste liquid tank 47 so that the tank 34 and the waste liquid tank 47 is replaceable as one cartridge at the same time.

In the above embodiment, the waste liquid tank 47 is a cartridge-type that can be replaceable with respect to the casing 30. The waste liquid tank 47 is not limited to one of which entirety is replaced. For example, a component forming the waste liquid tank 47, such as a liquid absorber, may be replaceable by pulling out part of the waste liquid tank 47 through the opening 17 of the front surface 30F of the casing 30.

The upper casing 31 is not limited to the configuration that pivots with respect to the lower casing 32. The internal space 30A of the casing 30 may be exposed to the outside by allowing the upper casing 31 to slide with respect to the lower casing 32 or removing the upper casing 31 from the lower casing 32.

What is claimed is:

1. A liquid discharge apparatus, comprising:
a casing having a first surface and a second surface positioned apart from each other in a first direction, a third surface and a fourth surface positioned apart from each other in a second direction perpendicular to the first direction, and a fifth surface and a sixth surface positioned apart from each other in a third direction perpendicular to the first direction and the second direction, the first surface having a first opening and a discharge opening through which a continuous sheet is discharged;
a waste liquid storage section positioned in an internal space of the casing and configured to be pulled out from the casing through the first opening;
a sheet accommodating section positioned between the waste liquid storage section and the second surface in the first direction in the internal space of the casing and configured to accommodate the continuous sheet;
a conveyor configured to convey the continuous sheet that extends from the sheet accommodating section to the discharge opening;
a head positioned between the waste liquid storage section and the fifth surface in the third direction in the internal space of the casing and configured to discharge liquid droplets; and
a maintenance unit positioned between the waste liquid storage section and the fifth surface in the third direction in the internal space of the casing, configured to receive liquid discharged from the head, and connected to the waste liquid storage section so that the liquid flows to the waste liquid storage section.

2. The liquid discharge apparatus according to claim 1, further comprising a first cover configured to open or close the first opening.

3. The liquid discharge apparatus according to claim 1, further comprising a second cover configured to slide with respect to the casing along the first direction so as to open or close a second opening formed in the fourth surface of the casing, wherein
the continuous sheet is installable in the sheet accommodating section through the second opening of the casing.

4. The liquid discharge apparatus according to claim 3, further comprising a first side frame and a second side frame positioned apart from each other in the second direction and extending in the first direction in the internal space of the casing,
wherein the waste liquid storage section, the sheet accommodating section, the conveyor, the head, and the maintenance unit are positioned between the first side frame and the second side frame in the second direction.

5. The liquid discharge apparatus according to claim 1, wherein the casing includes a first unit and a second unit, and
the first unit is configured to open the internal space of the casing to an outside of the liquid discharge apparatus by moving with respect to the second unit.

6. The liquid discharge apparatus according to claim 5, wherein the first unit is configured to pivot with respect to the second unit.

7. The liquid discharge apparatus according to claim 5, wherein the head is configured to pivot between a first position where the liquid droplets are discharged to the continuous sheet and a second position where a conveyance route through which the continuous sheet passes is opened.

8. The liquid discharge apparatus according to claim 1, further comprising:
a tank positioned in the internal space of the casing and configured to store the liquid, and
a supply unit positioned in the internal space of the casing and configured to supply the liquid to the head from the tank,
wherein the supply unit is positioned between the tank and the fifth surface in the third direction,
the head is positioned at one side in the second direction of the supply unit,
the maintenance unit is positioned between the head and the sixth surface in the third direction at the one side in the second direction of the supply unit, and
the waste liquid storage section is positioned at the one side in the second direction of the tank.

9. The liquid discharge apparatus according to claim 8, wherein the head, the maintenance unit, the waste liquid storage section and at least a part of the tank are positioned, in the second direction, in a range of a conveyance route through which the continuous sheet conveyed by the conveyor passes.

10. The liquid discharge apparatus according to claim 8, wherein the supply unit includes a pump configured to circulate the liquid in a nozzle of the head.

11. The liquid discharge apparatus according to claim 1, wherein the waste liquid storage section is a cartridge type that is configured to replace with respect to the casing.

12. The liquid discharge apparatus according to claim 2, wherein the waste liquid storage section faces the first cover in a state where the first cover closes the first opening.
